(19) United States
(12) Patent Application Publication
(10) Pub. No.: US 2018/0009683 A1
(43) Pub. Date: Jan. 11, 2018

(54) APPARATUS, SYSTEM, AND PROCESS FOR DEHALOGENATING AN AQUEOUS SALT SOLUTION

(71) Applicant: Harold Potts, Spring, TX (US)

(72) Inventor: Harold Potts, Spring, TX (US)

(73) Assignee: Global Oil and Water Solutions LLC, Spring, TX (US)

(21) Appl. No.: 15/204,258

(22) Filed: Jul. 7, 2016

(51) Int. Cl. C02F 1/461; C02F 103/36; C02F 103/08

(52) U.S. Cl. CPC C02F 1/46104; C02F 1/46109; C02F 2201/4618; C02F 2103/08; C02F 2001/46133; C02F 2209/06; C02F 2103/365

(57) ABSTRACT

An apparatus for dehalogenating an aqueous salt solution may include a tank, an electrode pair positioned at least partially within the tank, and an aerator positioned at least partially below an anode of the electrode pair. An inlet of the tank may be configured to introduce the aqueous salt solution into the tank, and as the aqueous salt solution contacts the electrode pair that may include a voltage potential between the anode and cathode, electrolysis occurs and the halogens in the aqueous salt solution, e.g. chloride, may be oxidized at the anode. The aerator may be configured to sweep the halogens to the top of the tank.

### BACKGROUND

The chloralkali process is one process used to desalinate an aqueous solution containing sodium chloride (NaCl), e.g., salt water. The chloralkali process converts the sodium chloride to chlorine gas, sodium hydroxide, and hydrogen gas via an electrolysis process. A membrane cell is used in the chloralkali process that separates a first chamber containing an anode from a second chamber that contains a cathode. Chloride ions are oxidized at the anode to produce the chlorine gas in the first chamber and hydrogen ions are reduced in the second chamber to produce the hydrogen gas and hydroxide ions (OH⁻). The sodium ions (Na⁺) from the first chamber pass through the membrane into the second chamber and react with the hydroxide ions to produce the sodium hydroxide.

The membrane is required to prevent the chlorine from reacting with the hydroxide ions, which would produce undesirable hypochlorites and hypochorates. Membranes are costly and require regular replacement. In addition, the anode in the chloralkali process needs to be made from a non-reactive metal, e.g., titanium, due to the corrosive nature of chlorine, which is expensive. Further, the process to remove chlorine from the aqueous sodium chloride solution generally takes an extended period of time to remove a sufficient amount of the sodium chloride from the solution to produce water with a low concentration of chlorides. Even still, while the chloralkali process removes halogens, e.g., chlorine, from the aqueous salt solution, aqueous sodium hydroxide is produced, rather than purified water.

What is needed, then, is an apparatus, system, and process for dehalogenating an aqueous salt solution that overcomes these challenges.

### SUMMARY

Embodiments of the invention may include an apparatus for dehalogenating an aqueous salt solution. The apparatus may include a tank that includes an inlet configured to introduce the aqueous salt solution into the tank, and an outlet configured to remove a dehalogenated aqueous solution from the tank. The apparatus may include at least one electrode pair positioned at least partially within the tank. Each electrode pair may include an anode and a cathode that are configured to be at least partially submerged in the aqueous salt solution, and each electrode pair may be configured to have a voltage potential between the anode and the cathode. The apparatus may further include an aerator positioned at least partially below the anode.

Embodiments of the invention may include a system for purifying water. The system may include a first tank that may include an inlet configured to introduce an aqueous salt solution into the first tank. The first tank may include a plurality of electrode pairs positioned at least partially within the first tank and positioned along a length of the first tank. Each of the plurality of electrode pairs may include an anode and a cathode that are configured to be at least partially submerged in the aqueous salt solution, and each of the plurality of electrode pairs may be configured to have a voltage potential between the anode and the cathode. The first tank may further include an aerator positioned at least partially below at least one anode, and an outlet configured to remove a dehalogenated water from the first tank. The system for purifying water may also include a second tank that may include an inlet configured to receive the dehalogenated water removed from the first tank. The second tank may further include an acid dispenser configured to add a mineral acid into the second tank, and an outlet configured to remove purified water from the second tank.

Embodiments of the invention may include a process for dehalogenating an aqueous salt solution. The process may include introducing an aqueous salt solution into a first tank that includes an electrode pair comprising an anode and a cathode. The process may include generating a voltage potential between the anode and the cathode to decompose a salt in the aqueous salt solution to produce a halogen gas. The process may further include bubbling a gas in the aqueous salt solution via an aerator positioned at least partially below an anode of the electrode pair.

### BRIEF DESCRIPTION OF THE DRAWINGS

The present disclosure is best understood from the following detailed description when read with the accompanying Figures. It is emphasized that, in accordance with the standard practice in the industry, various features are not drawn to scale. In fact, the dimensions of the various features may be arbitrarily increased or reduced for clarity of discussion.

FIG. 1 illustrates a block diagram of a system for dehalogenating an aqueous salt solution, according to at least one embodiment described.

FIG. 2 illustrates a top view of an electrolysis tank, according to at least one embodiment described.

FIG. 3 illustrates a side view of the electrolysis tank, according to at least one embodiment described.

FIG. 4 illustrates a side view of a pH adjustment tank, according to at least one embodiment described.

FIG. 5 illustrates a flow chart of the process for dehalogenating an aqueous salt solution, according to at least one embodiment described.

### DETAILED DESCRIPTION

It is to be understood that the following disclosure describes several exemplary embodiments for implementing different features, structures, or functions of the invention. Exemplary embodiments of components, arrangements, and configurations are described below to simplify the present disclosure; however, these exemplary embodiments are provided merely as examples and are not intended to limit the scope of the invention. Additionally, the present disclosure may repeat reference numerals and/or letters in the various exemplary embodiments and across the Figures provided herein. This repetition is for the purpose of simplicity and clarity and does not in itself dictate a relationship between the various exemplary embodiments and/or configurations discussed in the various Figures. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact. Finally, the exemplary embodiments presented below may be combined in any combination of ways, i.e., any element from one exemplary embodiment may be used in any other exemplary embodiment, without departing from the scope of the disclosure.

Additionally, certain terms are used throughout the following description and claims to refer to particular components. As one skilled in the art will appreciate, various entities may refer to the same component by different names, and as such, the naming convention for the elements described herein is not intended to limit the scope of the invention, unless otherwise specifically defined herein. Further, the naming convention used herein is not intended to distinguish between components that differ in name but not function. Additionally, in the following discussion and in the claims, the terms “including” and “comprising” are used in an open-ended fashion, and thus should be interpreted to mean “including, but not limited to.” All numerical values in this disclosure may be exact or approximate values unless otherwise specifically stated. Accordingly, various embodiments of the disclosure may deviate from the numbers, values, and ranges disclosed herein without departing from the intended scope. Furthermore, as it is used in the claims or specification, the term “or” is intended to encompass both exclusive and inclusive cases, i.e., “A or B” is intended to be synonymous with “at least one of A and B,” unless otherwise expressly specified herein.

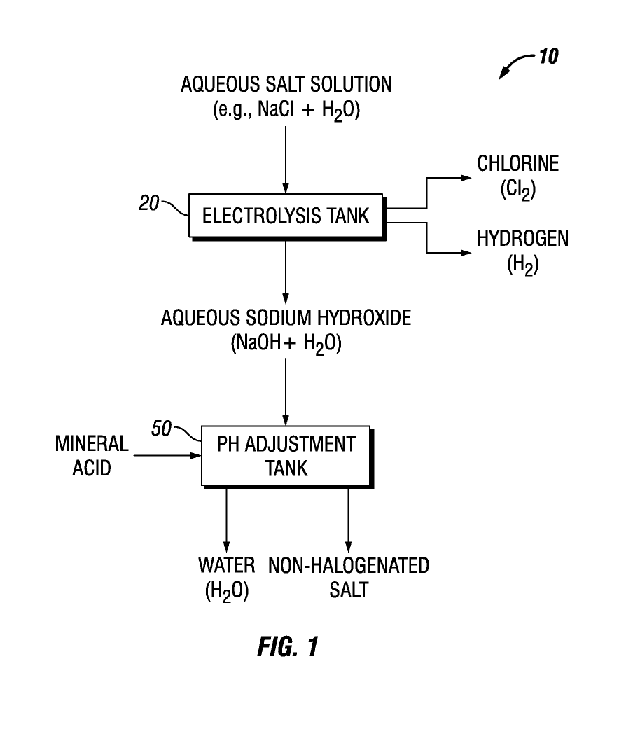

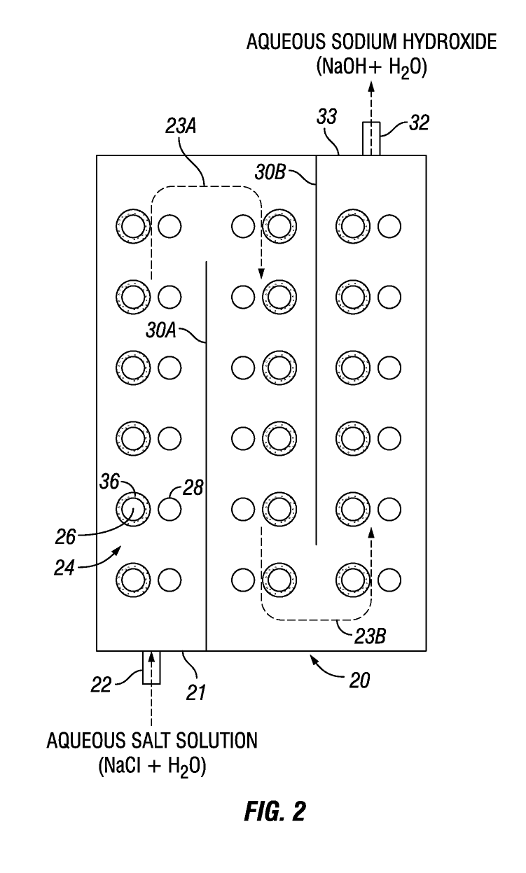

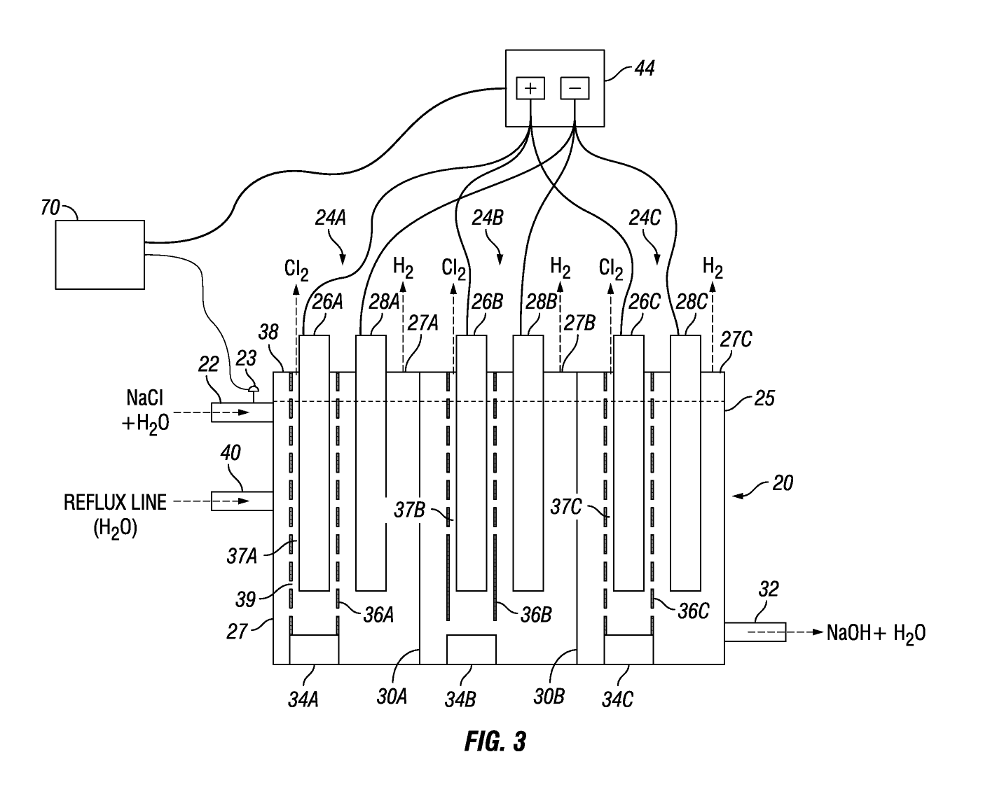

FIG. 1 illustrates a block diagram of a system 10 for dehalogenating an aqueous salt solution, according to at least one embodiment. The system 10 may include an electrolysis tank 20 configured to receive an aqueous salt solution, such as an aqueous sodium chloride solution. The aqueous salt solution may include high concentrations of salts, e.g., sodium chloride, and may include produced water from an oil well, frac water, ocean water, any other type of aqueous salt solution, or any mixture thereof. High concentration of salts may include any salt concentration over 500 ppm. The electrolysis tank 20 may include one or more electrode pairs 24 (shown in FIGS. 2 and 3) positioned between an inlet 22 and an outlet 32 of the tank 20. As the aqueous salt solution flows past the electrodes 24, electrolysis occurs, and hydrogen and chlorine may be separated out of the aqueous salt solution and removed from the electrolysis tank 20. After electrolysis of the aqueous salt solution, sodium hydroxide may be produced to provide an aqueous sodium hydroxide solution. The aqueous sodium hydroxide solution may exit the electrolysis tank 20 and, in one embodiment, enter a pH adjustment tank 20. One or more mineral acids may be added to the aqueous sodium hydroxide solution in the pH adjustment tank 50, which may produce a pH neutralized water and a non-halogenated salt.

FIG. 2 illustrates a top view of the electrolysis tank 20, and FIG. 3 illustrates a side view of the electrolysis tank 20, according to at least one embodiment. As shown in FIG. 2, the electrolysis tank 20 may include the inlet 22 positioned at a first end 21 of the tank 20, and the outlet 32 positioned at a second end 33 of the tank 20. However, in some embodiments, the outlet 32 may be positioned at the first end 21. The inlet 22 may be positioned proximal a top portion 25 of the tank 20, as shown in FIG. 3. The inlet 22 may be configured to receive the aqueous salt solution, which acts as an electrolyte in the electrolysis tank 20. In one embodiment, the electrolysis tank 20 may include an ion selective probe 23, shown in FIG. 3, which measures the concentration of halogens, e.g., sodium chloride, in the aqueous salt solution. The ion selective probe 23 may be at least partially disposed within the inlet 22 of the tank 20.

As discussed, the electrolysis tank 20 may include one or more electrode pairs 24 positioned between the inlet 22 and the outlet 32 of the tank 20. The electrode pairs 24 may be positioned at least partially within the tank 20, and may be positioned along a length of the tank 20. When the electrolysis tank 20 contains aqueous salt solution, the electrode pairs 24 may be at least partially submerged in the aqueous salt solution. The electrode pairs 24 may be positioned in a substantially vertical position within the tank 20. The electrode pairs 24 may also be positioned in line with one another and incrementally spaced from one another. However, in one embodiment, one or more of the electrode pairs 24 may be offset from one another or may include varied spacing between one another. Each electrode pair 24 may include an anode 26 and a cathode 28. In one or more exemplary embodiments, the anodes 26 and/or the cathodes 28 may include graphite, and/or may include a non-metallic material. In at least one exemplary embodiment, the anode 26 and/or the cathode 28 may include about 99% graphite, 99.2% graphite, 99.5% graphite, or 99.7% graphite. However, other materials for the anodes 26 and the cathodes 28 are contemplated, such as platinum, nickel, or titanium.

The electrode pairs 24 may be connected to a power supply 44, and an electrical potential may be applied to each electrode pair 24 via the power supply 44. In one embodiment, the power supply 44 may be or include a 12 volt/100 amp DC power supply 44. In one embodiment, the potential difference between the anode 26 and the cathode 28 may be about 1.23 volts or greater during electrolysis of the aqueous salt solution. In one exemplary embodiment, the potential difference between the anode 26 and the cathode 28 may be about 12 volts during electrolysis of the aqueous salt solution. As the electric potential applied across the electrode pairs 24 increases, the rate of electrolysis of the aqueous salt solution increases. In one embodiment, the potential difference between the anode 26 and the cathode 28 may be increased and/or decreased during electrolysis of the aqueous salt solution. As electric potential is applied to each electrode pair 24, halogens (e.g., chlorine) in the aqueous salt solution are oxidized at the surface of the anode 26 while sodium ions are reduced at the cathode 28. As a result, sodium hydroxide may be formed in the electrolysis tank 20, without the need of the sodium (Na⁺) to pass through a membrane as in the prior art.

In one embodiment, one or more aerators (three are shown, 34A, 34B, and 34C in FIG. 3) may be positioned at least partially below one or more anodes 26A, 26B, and 26C, respectively, within the electrolysis tank 20. The aerators 34A, 34B, 34C may be configured to produce gas bubbles in the aqueous salt solution that may travel upward and around the anode 26. Illustrative gases that can be produced by the aerators 34A, 34B, 34C may include, but are not limited to, air, nitrogen, helium, or any mixture thereof. In one embodiment, one or more sheaths (three are shown, 36A, 36B, and 36C in FIG. 3) may at least partially surround each anode 26A, 26B, and 26C, respectively, and may extend from a position proximal the aerator 34A, 34B, 34C, to the top portion 25 of the tank 20. In one embodiment, the sheath 36A, 36B, 36C may extend from a bottom end of the anode 26A, 26B, 26C to the top portion 25 of the tank 20. The sheath 36A, 36B, 36C may be made of a material that is an electrical insulator. Illustrative materials from which the sheaths 36A-C may be made of can include, but are not limited to, fiberglass, plastic, polytetrafluoroethylene, or a polyester such as biaxially-oriented polyethylene terophthalate. Polytetrafluoroethylene may include TEFLON® and polyethylene terephthalate may include MYLAR®. An inner surface of the sheath 36A, 36B, 36C may be positioned a distance away from the anodes 26A, 26B, 26C, respectively, thereby defining an annulus 37A, 37B, 37C between the sheath 26A, B, C and the anode 26A, B, C.

In one embodiment, the sheath 36A, 36B, 36C may include perforations 39 that are configured to allow aqueous salt solution to flow into and/or out of the annulus 37A, 37B, 37C. In one embodiment, the perforations 39 may be holes that extend through the sheath 36A, 36B, 36C. The perforations 39 may be oriented at an angle of about 20 degrees, about 30 degrees, or about 35 degrees to about 45 degrees, about 50 degrees, or about 60 degrees relative to the longitudinal axis of the anode 26A, 26B, 26C. The perforations 39 may be circular, triangular, rectangular, or any other suitable shape. The perforations 39 may have an average cross-sectional length, e.g., a diameter when the perforations 39 are circular, of about 0.05 inches, about 0.1 inches, or about 0.15 inches to about 0.2 inches, about 0.25 inches, or about 0.3 inches.

As the aqueous salt solution flows through the perforations 39, a Venturi effect may occur resulting in an increased flowrate of the aqueous salt solution flowing into the annulus 37A, 37B, 37C. As the chlorine is oxidized at the surface of the anode 26A, 26B, 26C, the combination of the increased aqueous salt solution flowrate into the annulus 37A, 37B, 37C and the gas bubbles from the aerator 34A, 34B, 34C moving the aqueous salt solution upward aid in sweeping or otherwise moving the chlorine to the top portion 25 of the tank 20. The chlorine may be removed from the tank 20, and in one embodiment, may be vented via one or more vents 27A, 27B, 27C positioned proximal the top portion 25 of the tank 20. In one embodiment, the chlorine may be removed via a line and collected in a separate vessel. The resultant rapid removal of chlorine from the solution in the tank 20 minimizes the formation of hypochlorites and hypochlorates in the solution, which may occur as hydroxyl ions within the water react with the chlorine gas.

The electrolysis tank 20 may include one or more partitions 30A, 30B, which extend vertically from a bottom portion 27 of the tank 20 to the top portion 25 of the tank 20. The partitions 30A, 30B, may extend along a portion of the length of the tank 20, wherein the partitions 30A, 30B may begin at one end of the tank 20 and terminate at a distance before the opposite end of the tank 20. Further, when two or more partitions 30A, 30B are positioned within the tank 20, the partitions 30A, 30B may begin at alternating sides of the tank 20, thereby leaving an open flow path for the aqueous salt solution to travel through the tank 20, as indicated by the arrows in FIG. 2. For example, the first partition 30A may begin at the first end 21 of the tank 20 and terminate at a distance before the second end 33 of the tank 20, and the second partition 30B may begin at the second end 33 of the tank and terminate at a distance before the first end 21 of the tank. Accordingly, the partitions 30A, 30B may define narrow channels within the tank 20, and may increase the distance the aqueous salt solution travels as it moves from the inlet 22 of the tank 20 to the outlet 32 of the tank 20. When the electrolysis tank 20 includes one or more partitions 30A, B, the electrode pairs 24 may be positioned at least partially within and along the length of each channel. As the aqueous salt solution moves from one channel to the next as indicated by the arrows 23A, 23B in FIG. 2, the change in direction of the fluid flow may result in a turbulent flow of the aqueous salt solution, which may increase contact of the aqueous salt solution and the electrode pairs 24. In one embodiment, however, electrolysis tank 20 may be free of any partitions 30A, B.

The electrolysis tank 20 may include a trough area positioned at the bottom portion 27 of the tank 20 where solids, e.g., metals, precipitated salts, and/or other materials, which may be found in the aqueous salt solution and/or that may be removed from the anodes 26 or cathodes 28 may be collected. The electrolysis tank 20 may also include a drain positioned proximal to the trough area, where the solids may be periodically removed from the tank 20. The trough area may include a plurality of trough areas positioned within each channel of the tank 20.

As the aqueous salt solution passes each electrode pair 24, the concentration of the halogens (chlorine) progressively reduces, and upon exit of the electrolysis tank 20, the halogen concentration in the water may be reduced to approximately zero. For example, the reduced halogen concentration in the water may be less than about 50 ppm, less than about 100 ppm, less than about 500 ppm, or less than about 1000 ppm. As the halogen concentration is reduced, the concentration of sodium hydroxide increases, which results in the pH level increasing within the solution.

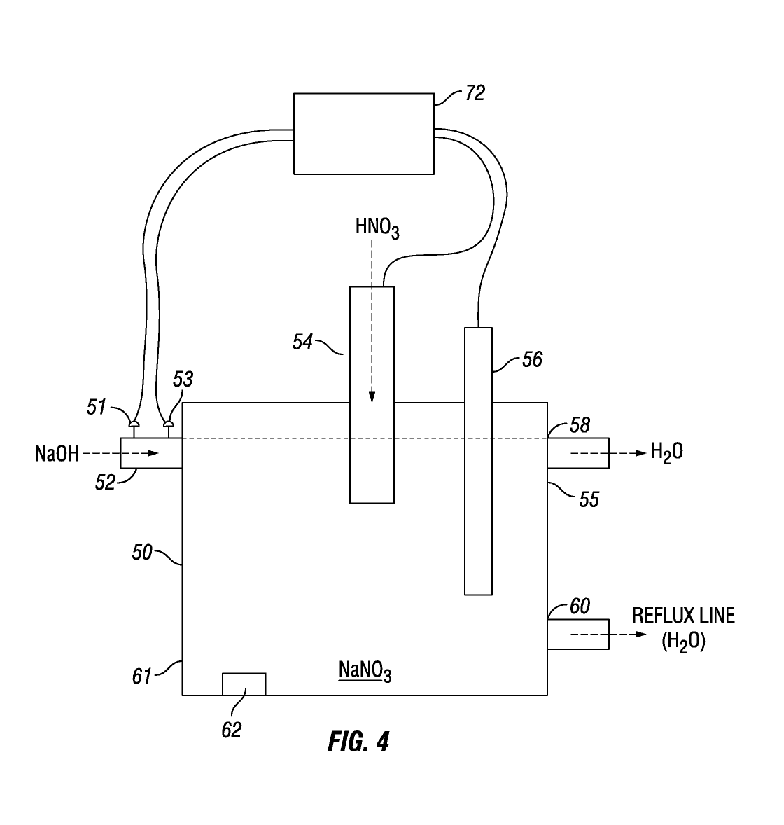

After all or most of the halogens have been removed from the aqueous salt solution, the sodium hydroxide and water (aqueous sodium hydroxide) may exit the electrolysis tank 20 via the outlet 32, and enter into the pH adjustment tank 50 via an inlet 52. FIG. 4 illustrates a side view of the pH adjustment tank 50, according to at least one embodiment of the invention. In one embodiment, the inlet 52 may be positioned proximal a top portion 55 of the pH adjustment tank 50. The pH adjustment tank 50 may include an acid dispenser 54, which in one embodiment, may include a feed pump. The acid dispenser 54 may be configured to dispense a mineral acid into the aqueous sodium hydroxide. In one embodiment, the mineral acid may include, but is not limited to, nitric acid, sulfuric acid, boric acid, phosphoric acid, or any mixture thereof. The amount of mineral acid added to the aqueous sodium hydroxide may be determined, at least in part, on the pH level of the aqueous sodium hydroxide, and in one embodiment, may be determined by the flowrate of the aqueous sodium hydroxide entering the tank 50. In one embodiment, a flow meter 51 and a pH probe 53 may be positioned at least partially within the inlet 52 of the pH adjustment tank 50 to detect the rate of aqueous sodium hydroxide entering the pH adjustment tank and the pH level of the aqueous sodium hydroxide.

When the mineral acid is added to the aqueous sodium hydroxide, a chemical reaction occurs producing a sodium salt. For example, if the mineral acid is nitric acid, the salt is sodium nitrate. The salt, e.g., sodium nitrate, can be separated from the water to produce a pH neutralized water. The mineral acid may be added to the sodium hydroxide until the mixture has a neutral pH level of about 6, about 6.5, or about 7 to about 7.5, about 8, or about 8.5.

In one embodiment, the pH adjustment tank 50 may include an aerator 62 positioned within the tank. For example, the aerator 62 may be positioned at a bottom portion 61 of the pH adjustment tank 50. The aerator 62 may aid in the mixing of the sodium hydroxide and the mineral acid. The pH adjustment tank 50 may also include a pH probe 56 positioned within the tank 50 configured to monitor the pH of the fluid contained within the tank 50 as the mineral acid is added to the tank 50.

In one embodiment, the pH probe 56 may be connected to a pH adjustment control system 70. The pH adjustment control system 70 may include one or more sensors, which may include the pH probes 53, 56, and/or the flow meter 51, which detects information relative to the pH adjustment tank 50. The pH adjustment control system 70 may be connected to a computer and include software configured to receive and analyze the information related to the solution entering the tank 50 and reacting within the pH adjustment tank 50. In one embodiment, the control system 70 may be connected to the acid dispenser 54 and configured to regulate the amount and/or rate of mineral acid added to the solution in order to reach a neutral pH level based on the information relative to the pH probes 53 and 56 and/or the flow meter 51.

In one embodiment, the power supply 44 providing the power to the electrode pairs 24 within the electrolysis tank 20 may be connected to an electrolysis control system 72. The electrolysis control system 72 may include one or more sensors that detect various aqueous salt solution properties entering or contained within the tank 20. For example, the electrolysis control system 72 may include sensors to detect the flowrate of the aqueous salt solution into the tank 20, the salinity of the aqueous salt solution, and the temperature of the aqueous salt solution. In one embodiment, the electrolysis control system 72 may include the ion selective probe 23 that may be configured to measure the concentration of halogen within the aqueous salt solution. The electrolysis control system 72 may be connected to the power supply 44 and configured to adjust the power provided to the electrode pairs 24 based on the aqueous salt solution properties. For example, the electrolysis control system 72 may adjust the potential difference in the electrode pairs 24 as the aqueous salt solution parameters change to ensure electrolysis occurs at a predetermined rate. In one embodiment, the electrolysis control system 72 and the pH adjustment control system 70 are part of the same control system.

In one embodiment, the electrolysis control system 72 may determine that the aqueous salt solution entering the electrolysis tank 20 contains a concentration of salt, e.g., sodium chloride, which may exceed a predetermined concentration of chlorides entering the electrolysis tank 20, which may be established by a user. In one embodiment, the predetermined concentration of chlorides in aqueous salt solution may be as high as about 330,000 parts per million. If the concentration of chlorides in the aqueous salt solution exceeds the predetermined concentration of chlorides, the electrolysis control system 72 and/or the pH adjustment control system 70 may be configured to selectively allow the electrolysis tank 20 to receive a portion of the de-halogenated water from a second outlet 60 of the pH adjustment tank 50 at a second inlet 40 of the electrolysis tank 20. The second inlet 40 of the electrolysis tank 20 may be positioned proximal the inlet 22 that is configured to receive the aqueous salt solution. The portion of the de-halogenated water may exit the pH adjustment tank 50 via a reflux line 60. The reflux line 60 may include a control valve that regulates the rate of de-halogenated water that flows to the electrolysis tank 20, and the reflux line 60 may include a check valve that prevents halogenated aqueous salt solution from flowing to the pH adjustment tank 50. The electrolysis control system 72 and/or the pH adjustment control system 70 may be configured to selectively allow an amount of de-halogenated water from the pH adjustment tank 50 into the electrolysis tank 20 such that the resultant concentration of chlorides proximal the inlet 22 of the electrolysis tank 20, given the inflow of aqueous salt solution and de-halogenated water, is below the predetermined concentration of chlorides.

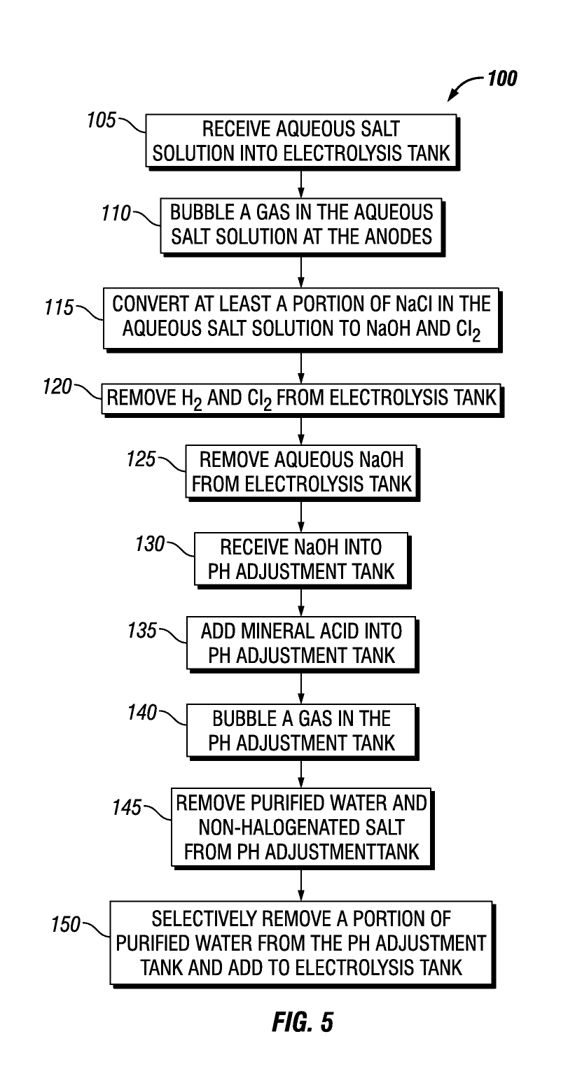

FIG. 5 illustrates a flow chart for a process for dehalogenating an aqueous salt solution, according to at least one embodiment. As discussed, the process may include introducing aqueous salt solution into an electrolysis tank 20, as at 105. The electrolysis tank 20 may include an electrode pair 24 for separating products out of the aqueous salt solution via electrolysis, with one of the products including a halogen. The process may include positioning a sheath 36 at least partially around an anode 26 of the electrode pair 24, with an inner surface of the sheath 36 and the anode 26 defining an annulus 37. The sheath 36 may include a plurality of perforations 39 therethrough. The process may include bubbling a gas, e.g., air, via an aerator 34 through the aqueous salt solution at the anode 26 of the electrode pair 24, as at 110. The process may include converting at least a portion of the salt in the aqueous salt solution into sodium hydroxide and chlorine gas, as at 115. The process may further include removing hydrogen and chlorine from the tank 20, as at 120. The process may include removing the resultant aqueous sodium hydroxide from the electrolysis tank 20, as at 125, and receiving the aqueous sodium hydroxide into a pH adjustment tank 50, as at 130. The process may include adding one or more mineral acids, e.g., nitric acid, into the pH adjustment tank as, at 135. The process may further include bubbling a gas, e.g., air, through the contents of the pH adjustment tank 50 via an aerator 62, as at 140, in order to thoroughly mix the sodium hydroxide and the mineral acid. The process may include removing the resultant pH neutralized water and non-halogenated salt from the pH adjustment tank 50, as at 145. In one embodiment, the non-halogenated salt may be sodium nitrate. The process may further include selectively removing a portion of the resultant dehalogenated water from the pH adjustment tank 50 and adding the portion of the dehalogenated water to the electrolysis tank 20.

Embodiments of the present disclosure further relate to any one or more of the following paragraphs:

1. An apparatus for dehalogenating an aqueous salt solution, comprising: a tank comprising: an inlet configured to introduce the aqueous salt solution into the tank, and an outlet configured to remove a dehalogenated aqueous solution from the tank; at least one electrode pair positioned at least partially within the tank, wherein each electrode pair comprises an anode and a cathode that are configured to be at least partially submerged in the aqueous salt solution, and wherein each electrode pair is configured to have a voltage potential between the anode and the cathode; and an aerator positioned at least partially below the anode.

2. The apparatus of claim 1, further comprising: a sheath at least partially surrounding the anode, an inner surface of the sheath positioned at a distance from the anode and thereby defining an annulus that at least partially surrounds the anode, the sheath comprising a plurality of perforations formed therethrough, wherein the plurality of perforations is configured to allow the aqueous salt solution to flow into the annulus.

3. The apparatus of claim 2, further comprising: a partition extending from the bottom portion of the tank to the top portion of the tank, the partition extending from a first end of the tank to a location at a distance from the second end of the tank, the partition thereby defining channels within the tank.

4. The apparatus of claim 2, wherein the tank further includes a vent at the top portion of the tank that is configured to remove chlorine gas and hydrogen gas from the tank.

5. The apparatus of claim 2, wherein the anode and the cathode comprise a non-metallic material.

6. The apparatus of claim 5, wherein the non-metallic material is graphite.

7. A system for purifying water, comprising:a first tank comprising: an inlet configured to introduce an aqueous salt solution into the first tank, a plurality of electrode pairs positioned at least partially within the first tank and positioned along a length of the first tank, wherein each of the plurality of electrode pairs comprises an anode and a cathode that are configured to be at least partially submerged in the aqueous salt solution, wherein each of the plurality of electrode pairs is configured to have a voltage potential between the anode and the cathode, an aerator positioned at least partially below at least one anode, and an outlet configured to remove a dehalogenated water from the first tank; and a second tank comprising: an inlet configured to receive the dehalogenated water removed from the first tank, an acid dispenser configured to add a mineral acid into the second tank, and an outlet configured to remove purified water from the second tank.

8. The system of claim 7, wherein the first tank further comprises a sheath at least partially surrounding each of the anodes, an inner surface of the sheaths positioned at a distance from the anodes thereby defining an annulus that at least partially surrounds each of the anodes, and the sheaths including a plurality of perforations therethrough that are configured to allow the aqueous salt solution to flow into the annulus.

9. The system of claim 8, wherein the anode of each electrode pair comprises graphite.

10. The system of claim 8, wherein the mineral acid comprises nitric acid.

11. The system of claim 8, wherein the second tank further comprises a pH probe configured to monitor a pH of the dehalogenated water contained therein.

12. The system of claim 11, further comprising a control system connected to the pH probe and the acid dispenser, wherein the control system is configured to regulate an amount of mineral acid added by the acid dispenser into the second tank is based on the monitored pH.

13. The system of claim 12, wherein the control system is further connected to a sensor positioned proximal the inlet of the first tank and configured to measure a concentration of sodium chloride in the aqueous salt solution introduced to the first tank.

14. The system of claim 13, wherein the system further comprises a reflux line configured to selectively deliver at least a portion of the purified water removed from the second tank to the first tank.

15. The system of claim 14, wherein purified water is delivered to the first tank when the sensor positioned proximal the inlet of the first tank indicates the sodium chloride concentration exceeds a predetermined amount.

16. The system of claim 15, wherein the predetermined amount of sodium chloride is about 330,000 parts per million.

17. The system of claim 8, wherein the second tank further comprises a second aerator.

18. A process for dehalogenating an aqueous salt solution, comprising: introducing an aqueous salt solution into a first tank that includes an electrode pair comprising an anode and a cathode; generating a voltage potential between the anode and the cathode to decompose a salt in the aqueous salt solution to produce a halogen gas; and bubbling a gas in the aqueous salt solution via an aerator positioned at least partially below an anode of the electrode pair.

19. The process of claim 18, further comprising: removing the halogen from the first tank thereby producing dehalogenated water.

20. The process of claim 18, wherein a sheath at least partially surrounds an anode of the electrode pair and comprises a plurality of perforations formed therethrough, an inner surface of the sheath positioned at a distance from the anode and thereby defining an annulus that at least partially surrounds the anode, the process further comprising: flowing the aqueous salt solution through the perforations and into the annulus.

21. The process of claim 18, wherein the anode comprises graphite.

It should be appreciated that all numerical values and ranges disclosed herein are approximate valves and ranges, whether “about” is used in conjunction therewith. It should also be appreciated that the term “about,” as used herein, in conjunction with a numeral refers to a value that is +/−5% (inclusive) of that numeral, +/−10% (inclusive) of that numeral, or +/−15% (inclusive) of that numeral. It should further be appreciated that when a numerical range is disclosed herein, any numerical value falling within the range is also specifically disclosed.
The foregoing has outlined features of several embodiments so that those skilled in the art may better understand the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure.

We claim:

1. An apparatus for dehalogenating an aqueous salt solution, comprising:
a tank comprising:
an inlet configured to introduce the aqueous salt solution into the tank, and
an outlet configured to remove a dehalogenated aqueous solution from the tank;
at least one electrode pair positioned at least partially within the tank, wherein each electrode pair comprises an anode and a cathode that are configured to be at least partially submerged in the aqueous salt solution, and wherein each electrode pair is configured to have a voltage potential between the anode and the cathode; and
an aerator positioned at least partially below the anode.

2. The apparatus of claim 1, further comprising:
a sheath at least partially surrounding the anode, an inner surface of the sheath positioned at a distance from the anode and thereby defining an annulus that at least partially surrounds the anode, the sheath comprising a plurality of perforations formed therethrough, wherein the plurality of perforations is configured to allow the aqueous salt solution to flow into the annulus.

3. The apparatus of claim 2, further comprising:
a partition extending from the bottom portion of the tank to the top portion of the tank, the partition extending from a first end of the tank to a location at a distance from the second end of the tank, the partition thereby defining channels within the tank.

4. The apparatus of claim 2, wherein the tank further includes a vent at the top portion of the tank that is configured to remove chlorine gas and hydrogen gas from the tank.

5. The apparatus of claim 2, wherein the anode and the cathode comprise a non-metallic material.

6. A system for purifying water, comprising:
a first tank comprising:
an inlet configured to introduce an aqueous salt solution into the first tank,
a plurality of electrode pairs positioned at least partially within the first tank and positioned along a length of the first tank, wherein each of the plurality of electrode pairs comprises an anode and a cathode that are configured to be at least partially submerged in the aqueous salt solution, wherein each of the plurality of electrode pairs is configured to have a voltage potential between the anode and the cathode,
an aerator positioned at least partially below at least one anode, and
an outlet configured to remove a dehalogenated water from the first tank; and
a second tank comprising:
an inlet configured to receive the dehalogenated water removed from the first tank,
an acid dispenser configured to add a mineral acid into the second tank, and
an outlet configured to remove purified water from the second tank.

7. The system of claim 6, wherein the first tank further comprises a sheath at least partially surrounding each of the anodes, an inner surface of the sheaths positioned at a distance from the anodes thereby defining an annulus that at least partially surrounds each of the anodes, and the sheaths including a plurality of perforations therethrough that are configured to allow the aqueous salt solution to flow into the annulus.

8. The system of claim 7, wherein the anode of each electrode pair comprises graphite.

9. The system of claim 7, wherein the mineral acid comprises nitric acid.

10. The system of claim 7, wherein the second tank further comprises a pH probe configured to monitor a pH of the dehalogenated water contained therein.

11. The system of claim 10, further comprising a control system connected to the pH probe and the acid dispenser, wherein the control system is configured to regulate an amount of mineral acid added by the acid dispenser into the second tank is based on the monitored pH.

12. The system of claim 11, wherein the control system is further connected to a sensor positioned proximal the inlet of the first tank and configured to measure a concentration of sodium chloride in the aqueous salt solution introduced to the first tank.

13. The system of claim 12, wherein the system further comprises a reflux line configured to selectively deliver at least a portion of the purified water removed from the second tank to the first tank.

14. The system of claim 13, wherein purified water is delivered to the first tank when the sensor positioned proximal the inlet of the first tank indicates the sodium chloride concentration exceeds a predetermined amount.

15. The system of claim 14, wherein the predetermined amount of sodium chloride is about 330,000 parts per million.

16. The system of claim 7, wherein the second tank further comprises a second aerator.

17. A process for dehalogenating an aqueous salt solution, comprising:
introducing an aqueous salt solution into a first tank that includes an electrode pair comprising an anode and a cathode;
generating a voltage potential between the anode and the cathode to decompose a salt in the aqueous salt solution to produce a halogen gas; and
bubbling a gas in the aqueous salt solution via an aerator positioned at least partially below an anode of the electrode pair.

18. The process of claim 17, further comprising:
removing the halogen from the first tank thereby producing dehalogenated water.

19. The process of claim 17, wherein a sheath at least partially surrounds an anode of the electrode pair and comprises a plurality of perforations formed therethrough, an inner surface of the sheath positioned at a distance from the anode and thereby defining an annulus that at least partially surrounds the anode, the process further comprising:
flowing the aqueous salt solution through the perforations and into the annulus.

20. The process of claim 17, wherein the anode comprises graphite.
